(19) United States
(12) Patent Application Publication
(10) Pub. No.: US 2026/0201903 A1
(43) Pub. Date: Jul. 16, 2026

(54) FAN, A FAN SYSTEM INCLUDING A FAN AND A MOUNTING ASSEMBLY, AND METHOD OF MOUNTING A FAN

(71) Applicant: SkyBlade Fan Company, Warren, MI (US)

(72) Inventors: Jonathon Jones, Warren, MI (US); John Wortman, Grosse Pointe Farms, MI (US)

(21) Appl. No.: 19/451,139

(22) Filed: Jan. 16, 2026

Related U.S. Application Data
(60) Provisional application No. 63/746,012, filed on Jan. 16, 2025.
(60) Provisional application No. 63/755,435, filed on Feb. 7, 2025.

(51) Int. Cl. F04D 29/52; F04D 15/00; F04D 25/08; F04D 29/64

(52) U.S. Cl. CPC F04D 29/522; F04D 15/0066; F04D 25/088; F04D 29/646; F05D 2240/90

(57) ABSTRACT

A fan includes a cage housing, a central hub, a plurality of airfoils supported within the cage housing for rotation, and a motor assembly coupled to a mounting plate of the cage housing and the central hub for rotating the central hub and the plurality of airfoils. A mounting assembly may be coupled to the mounting plate to support the fan relative to a mounting structure and includes an upper mounting bracket assembly for coupling to the mounting structure, a lower mounting bracket assembly coupled to the mounting plate, and an extension member extending between the upper and lower mounting bracket assemblies. A method of mounting the fan includes permitting the extension member, the lower bracket assembly, and the fan to pivot about an adjustment axis until they reach a static equilibrium orientation relative to the upper mounting bracket assembly, and retaining them at the static equilibrium orientation.

### CROSS-REFERENCE TO RELATED APPLICATIONS

The present application claims priority to and all the benefits of U.S. Provisional Patent Application No. 63/746,012 filed Jan. 16, 2025, and U.S. Provisional Patent Application No. 63/755,435 filed Feb. 7, 2025, each of which are hereby expressly incorporated herein by reference in their entirety.

### TECHNICAL FIELD

The present disclosure relates generally to a high volume low speed (“HVLS”) fan, a directional fan system including a directional fan assembly and a mounting assembly for supporting the directional fan assembly relative to a mounting structure, and method of mounting fan assemblies.

### BACKGROUND

Fans are commonly deployed in large industrial and commercial spaces to circulate air, and are often implemented as free-standing floor fans, ceiling mounted fans, or wall or column mounted fans. There are challenges in the art associated with each type of fan recited above in terms of assembling the fans themselves, servicing and/or maintaining the fans, mounting the fans at a desired location, and orienting and/or modifying the airflow of these fans to achieve desired performance. Accordingly, there is a need in the art for improved fans, fan systems including fans and mounting assemblies, and methods of mounting fans.

### SUMMARY

One general aspect of the present disclosure is directed to a high volume low speed (“HVLS”) fan. The HVLS fan includes a cage housing. The cage housing includes a front cage section, a rear cage section spaced from the front cage section along a central axis, and a cylindrical cage section disposed annularly about the central axis and between the front cage section and the rear cage section such that the front cage section, the rear cage section, and the cylindrical cage section cumulatively define a housing interior. The rear cage section includes a mounting plate having an interior surface facing the housing interior and an exterior surface opposite the interior surface. The HVLS fan also includes a fan assembly disposed in the housing interior of the cage housing. The fan assembly includes a central hub supported for rotation about the central axis, and a plurality of airfoils coupled to and distributed circumferentially about the central hub for rotation about the central axis with the central hub. The HVLS fan also includes a motor assembly coupled to the mounting plate of the rear cage section of the cage housing. The motor assembly includes a motor housing portion disposed in the housing interior and coupled to the interior surface of the mounting plate, a stator disposed in the motor housing portion, a rotor disposed in the motor housing portion and configured for rotation about the central axis in response to energization of the stator, and a motor shaft coupled to the rotor and the central hub of the fan assembly such that the fan assembly rotates about the central axis in response to rotation of the rotor. The motor assembly also includes a controller housing portion extending from the motor housing portion beyond the exterior surface of the mounting plate such that the controller housing portion is at least partially disposed outside of the housing interior of the cage housing. The motor assembly further includes an onboard controller in communication with the stator for selectively controlling energization of the stator, where the onboard controller is disposed in the controller housing portion of the motor assembly such that the onboard controller is external to the cage housing.

Another general aspect of the present disclosure is directed to a directional fan system. The directional fan system includes a directional fan assembly including a cage housing. The cage housing includes a front cage section, a rear cage section spaced from the front cage section along a central axis and including a mounting plate, and a cylindrical cage section disposed annularly about the central axis and extending between the front cage section and the rear cage section such that the front cage section, the rear cage section, and the cylindrical cage section cumulatively define a housing interior. The directional fan assembly also includes a central hub supported for rotation about the central axis and a plurality of airfoils coupled to and distributed circumferentially about the central hub for rotation about the central axis with the central hub. The directional fan assembly further includes a motor assembly coupled to the mounting plate of the rear cage section of the cage housing and including a motor shaft coupled to the central hub such that the central hub and the plurality of airfoils rotate about the central axis in response to rotation of the motor shaft. The directional fan system also includes a mounting assembly configured to support the directional fan assembly relative to a mounting structure. The mounting assembly includes an upper mounting bracket assembly configured to be coupled to the mounting structure, an extension member having a top portion coupled to the upper mounting bracket assembly and a bottom portion, and a lower mounting bracket assembly. The lower mounting bracket assembly includes a yoke having a first yoke arm coupled to the mounting plate, a second yoke arm coupled to the mounting plate and spaced from the first yoke arm, and a central yoke portion coupled to and extending between the first yoke arm and the second yoke arm, with the central yoke portion coupled to the bottom portion of the extension member. The yoke is pivotably coupled to one of the mounting plate and the bottom portion of the extension member such that the yoke is pivotable about a pivot axis to adjust an orientation of the directional fan assembly.

A further general aspect of the present disclosure includes a method of mounting a directional fan assembly to a ceiling mounting structure. The method includes coupling a top plate of an upper mounting bracket assembly to the ceiling mounting structure, with the upper mounting bracket assembly including a pair of adjustment brackets defining coaxial bores defining an adjustment axis, and an adjustment slot radially spaced from the adjustment axis. The method also includes coupling a top portion of an extension member to the pair of adjustment brackets by disposing a fastener through the coaxial bores and the top portion of the extension member such that the extension member is pivotable about the adjustment axis. The method also includes coupling a bottom portion of the extension member to a directional fan assembly with a lower bracket assembly such that the directional fan assembly is supported by the extension member. The method also includes adjusting the lower bracket assembly to support the directional fan assembly at an orientation relative to the extension member. The method also includes permitting the extension member, the lower bracket assembly, and the directional fan assembly to pivot about the adjustment axis until the extension member, the lower bracket assembly, and the directional fan assembly reach a static equilibrium orientation relative to the upper mounting bracket assembly. The method also includes disposing a fastener through the adjustment slot and the top portion of the extension member to retain the extension member, the lower bracket assembly, and the directional fan assembly at the static equilibrium orientation.

### BRIEF DESCRIPTION OF THE DRAWINGS

Other advantages of the present disclosure will be readily appreciated, as the same becomes better understood by reference to the following detailed description when considered in connection with the accompanying drawings.

FIG. 1 is a front perspective view of an HVLS fan according to one embodiment of the subject disclosure.

FIG. 2 is a front view of the HVLS fan of FIG. 1.

FIG. 3 is a side view of the HVLS fan of FIG. 1.

FIG. 4 is a rear perspective view of the HVLS fan of FIG. 1.

FIG. 5 is an enlarged rear perspective view of the HVLS fan of FIG. 1.

FIG. 6 is an exploded front perspective view of the HVLS fan of FIG. 1.

FIG. 7 is a partial cross-sectional representation of the HVLS fan taken along line 7-7 in FIG. 2.

FIG. 8 is a rear perspective view of another embodiment of an HVLS fan further including an orifice ring.

FIG. 9 is a side view of the HVLS fan of FIG. 8.

FIG. 10 is a partial cross-sectional representation of the HVLS fan taken along line 10-10 in FIG. 8.

FIG. 11 is a front perspective view of a directional fan system according to the present disclosure supported relative to a ceiling mounting structure.

FIG. 12 is a rear perspective view of the directional fan system of FIG. 11.

FIG. 13 is a side view of the directional fan system of FIG. 11.

FIG. 14 is a partial cross-sectional representation of the directional fan system of FIG. 11 taken along line 14-14 in FIG. 12.

FIG. 15 shows another version of the directional fan system according to the present disclosure including a lower mounting bracket assembly where a central yoke portion of a yoke is coupled to a bottom portion of an extension member in an adjustable manner.

FIG. 16 is a front perspective view of another version of the directional fan system according to the present disclosure including an upper mounting bracket assembly coupled to a top portion of the extension member in an adjustable manner.

FIGS. 17A-17I schematically a variety of other exemplary configurations of the upper mounting bracket assembly and top portion of the extension member according to the present disclosure.

FIG. 18 is a rear perspective view of another version of the directional fan system according to the present disclosure supported relative to a wall or column mounting structure.

FIG. 19 is a front perspective view of the directional fan system of FIG. 18.

FIG. 20 is a flowchart illustrating a method of mounting a directional fan assembly to a ceiling mounting structure according to the present disclosure.

FIG. 21 is a partial rear perspective view of another version of the direction fan system including another version of the lower mounting bracket assembly according to the present disclosure.

FIG. 22 is a partial rear view of the lower mounting bracket assembly of FIG. 21.

### DETAILED DESCRIPTION

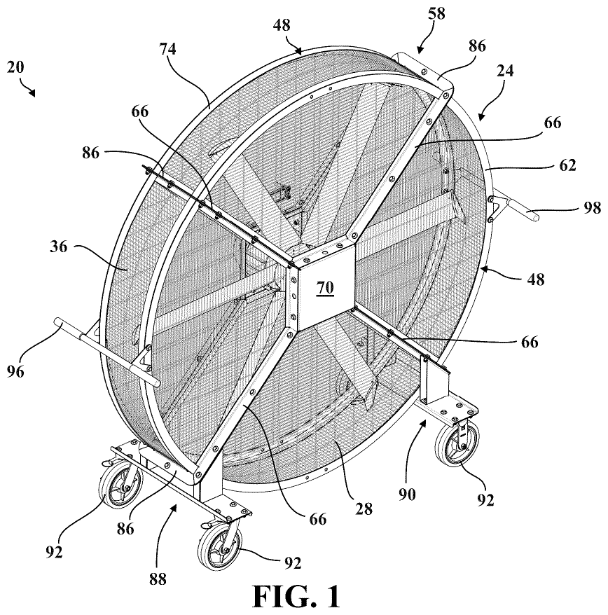

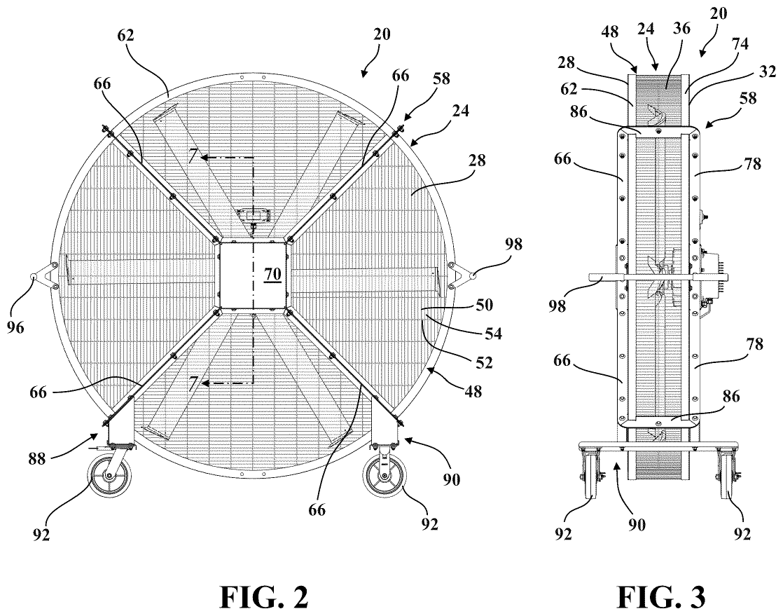

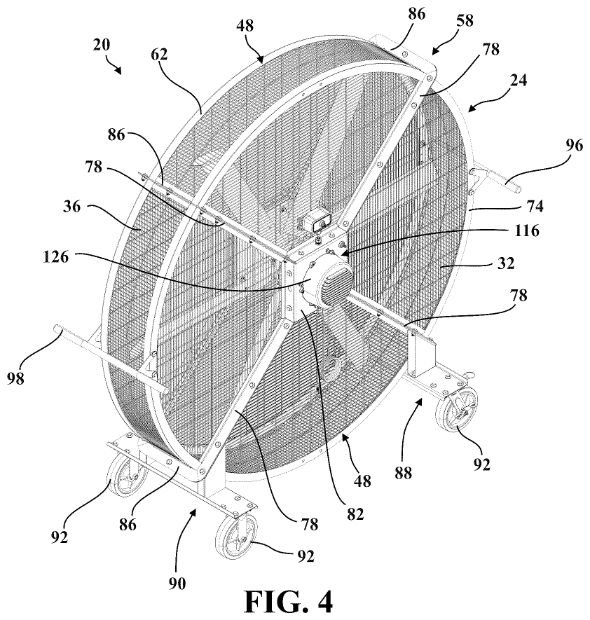

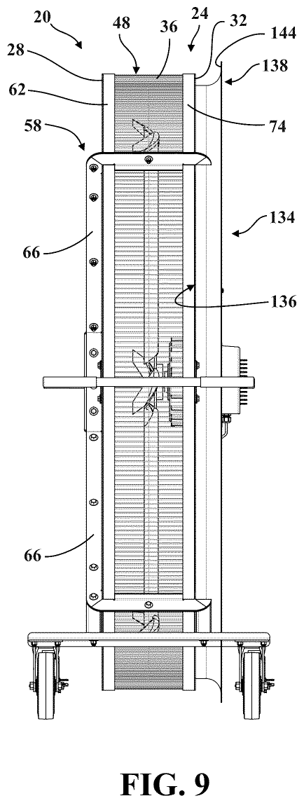

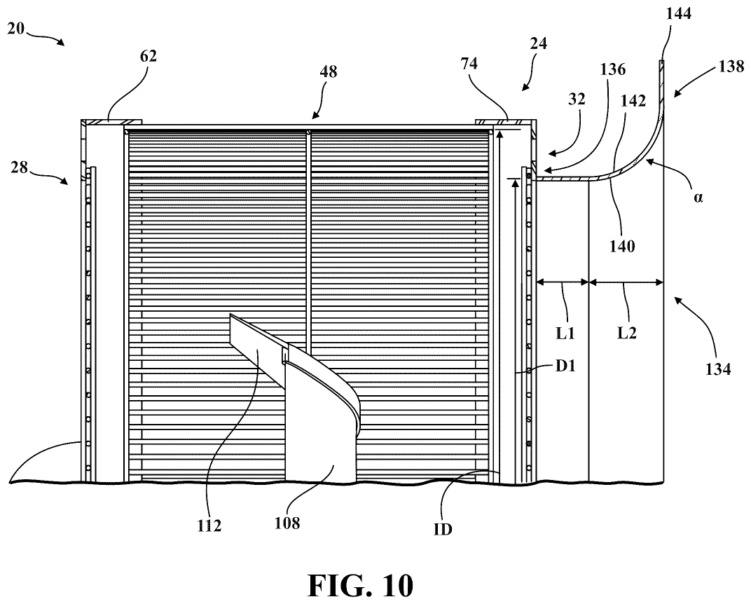

With reference to the FIGS., wherein like numerals indicate like parts throughout the several views, FIGS. 1-10 illustrate a high volume low speed (“HVLS”) fan 20 according to the present disclosure. As used herein, the phrase “high volume low speed fan” refers to fan configured to move a relatively large volumetric airflow rate while operating at a relatively low rotational speed (e.g. compared to conventional smaller-diameter, higher-RPM fans), such that the fan produces broadly distributed airflow within a space. In FIGS. 1-10, the HVLS fan 20 is implemented as an upright floor-standing HVLS fan, but other configurations including, but not limited to, ceiling mounted fans, and wall or column mounted fans are contemplated.

Referring to FIGS. 1-7, the HVLS fan 20 includes a cage housing 24. The cage housing 24 generally includes a front cage section 28, a rear cage section 32 spaced from the front cage section 28 along a central axis CA, and a cylindrical cage section 36 disposed annularly about the central axis CA and between the front cage section 28 and the rear cage section 32 such that the front cage section 28, the rear cage section 32, and the cylindrical cage section 36 cumulatively define a housing interior 40. The HVLS fan 20 also includes a fan assembly 100 (described in further detail below) disposed in the housing interior 40 of the cage housing 24 for rotation about the central axis CA. During operation of the HVLS fan 20, rotation of the fan assembly 100 about the central axis CA draws air through the rear cage section 32 and directs the air through the housing interior 40 and out of the front cage section 28 while the cage housing 24 inhibits inadvertent contact with the fan assembly 100.

The cage housing 24 may have any construction suitable for permitting airflow therethrough and inhibiting inadvertent contact with the fan assembly 100. For example, the front cage section 28, the rear cage section 32, and the cylindrical cage section 36 of the cage housing 24 generally include a wire grid structure 48. The wire grid structure 48 may include multiple pluralities of wires 50, 52 arranged relative to each other to define grid openings 54 that permit airflow therethrough. In some examples, the wire grid structure 48 may have a polar arrangement with a first plurality of wires 50 extending circumferentially about the central axis CA and a second plurality of wires 52 extending radially relative to the central axis CA to define the wire grid structure 48. In the illustrated configuration, the wire grid structure 48 has a rectilinear arrangement with the first plurality of wires 50 extending in a first direction and the second plurality of wires 52 extending in a second direction transverse to the first direction to define the wire grid structure 48. The first and second plurality of wires 50, 52 may be spaced relative to each other at any suitable distance for the application. The respective size and shape of the grid openings 54 may differ depending on the desired airflow of the HVLS fan 20 during operation and are dictated by the respective distance between adjacent wires of the first and second plurality of wires 50, 52. In some examples, the cylindrical cage section 36 of the cage housing 24 may be formed without openings, such as from sheet metal or the like.

While a variety of configurations of the cage housing 24 for supporting the wire grid structure 48 (and other components of the HVLS fan 20, as described in further detail below) are contemplated, in the configuration illustrated in FIGS. 1-7, the cage housing 24 includes a frame assembly 58 relative to which the wire grid structure 48 is mounted. At the front cage section 28, the frame assembly 58 includes a front frame ring 62 disposed concentric with the central axis CA and relative to which the wire grid structure 48 is secured. Although not required, FIGS. 1-7 illustrate front radial frame members 66 coupled to the front frame ring 62 and extending radially inward from the front frame ring 62 toward the central axis CA to a front frame hub 70. The front radial frame members 66 and the front frame hub 70 may provide additional mounting structure relative to which the wire grid structure 48 may be secured. At the rear cage section 32, the frame assembly 58 includes a rear frame ring 74 disposed concentric with the central axis CA and rear radial frame members 78 coupled to the rear frame ring 74 and extending radially inward from the rear frame ring 74 toward the central axis CA to support a mounting plate 82. As described in further detail below, the fan assembly 100 and a motor assembly 116 are supported relative to the mounting plate 82. At the cylindrical cage section 36, the wire grid structure 48 is secured to and extends between the front frame ring 62 and the rear frame ring 74, and the frame assembly 58 may include axial radial frame members 86 extending between the front frame ring 62 and the rear frame ring 74 to define the spacing therebetween. Other configurations of the frame assembly 58 are contemplated.

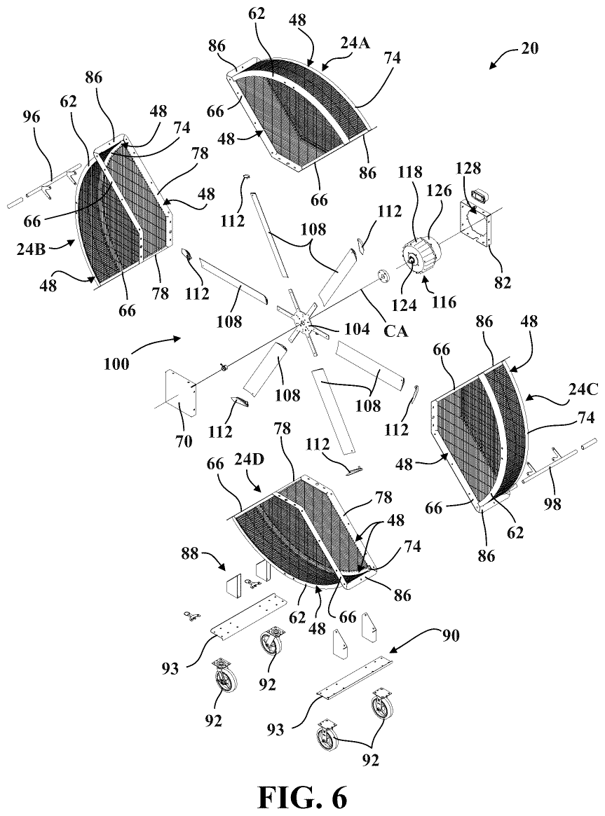

In configurations where the HVLS fan 20 is implemented as an upright floor-standing HVLS fan 20, as illustrated in FIGS. 1-7, the frame assembly 58 may include a pair of wheel supports 88, 90 that are each coupled to the cylindrical cage section 36. A plurality of wheels 92, shown in FIGS. 1-7 as caster wheels 92, may be coupled to and extend from a bottom surface 93 of the respective wheel supports 88, 90. Additionally, the frame assembly 58 may also include a pair of handles 96, 98 each extending between the front frame ring 62 and the rear frame ring 74 and arranged for user engagement to maneuver the HVLS fan 20 along a floor surface. The handles 96, 98 preferably extend horizontal relative to the floor on which the fan 20 is positioned (e.g. parallel to the central axis CA) and are arranged at a height from the floor that is approximately midway between the topmost part of the cylindrical cage section 36 and the bottommost point of the cylindrical cage section 36 relative to the floor. Collectively, the handles 96, 98 and the wheels 92 allow the user to easily move the HVLS fan 20 along the floor to a desired position. FIG. 6 shows an exploded view of the HVLS fan 20. In this configuration, the cage housing 24 includes four quadrant sub-assemblies 24A, 24B, 24C, and 25D that are coupled to cumulatively define the cage housing 24. Other arrangements of the cage housing 24 which are assembled in a different manner are contemplated.

With continued reference to FIGS. 1-7, as alluded to above, the HVLS fan 20 includes the fan assembly 100. The fan assembly 100 is disposed in the housing interior 40 of the cage housing 24 for rotation about the central axis CA. The fan assembly 100 includes a central hub 104 supported for rotation about the central axis CA and a plurality of airfoils 108 coupled to and distributed circumferentially about the central hub 104 for rotation about the central axis CA with the central hub 104. As described in further detail below, the central hub 104 is coupled to the motor assembly 116 such that the central hub 104 and the plurality of airfoils 108 are supported for rotation about the central axis CA. Each airfoil 108 of the plurality of airfoils 108 is typically formed out of a lightweight material such as aluminum or a composite that can be formed into an airplane wing type shape with a hollow core. However, it should be appreciated that the plurality of airfoils 108 can be formed of a variety of different materials, including plastics, polyurethanes, and other suitably rigid materials adequate to form an airfoil, or even combinations of such materials known to those skilled in the art. It should also be appreciated that the length of each airfoil 108 of the plurality of airfoils 108 relative to the central axis CA can be increased or decreased to suit a certain application. Generally, the diameter of the plurality of airfoils 108 is less than an inner diameter of the cylindrical cage section 36, but the gap between the plurality of airfoils 108 and the inner diameter of the cylindrical cage section 36 can vary depending on the application. Although not required, each airfoil 108 of the plurality of airfoils 108 can further include a wingtip fence 112 for conditioning airflow near a radially outer end of each airfoil 108. Each wingtip fence 112 may extend generally transverse to its corresponding airfoil 108 and may be formed as integral portions of the airfoil 108 or as separate components secured thereto. Other configurations of wingtip fences 112 are contemplated.

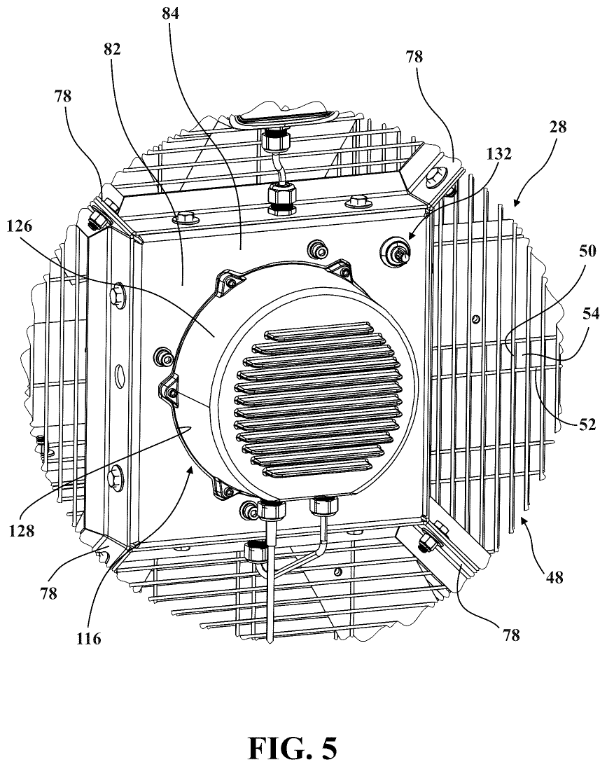

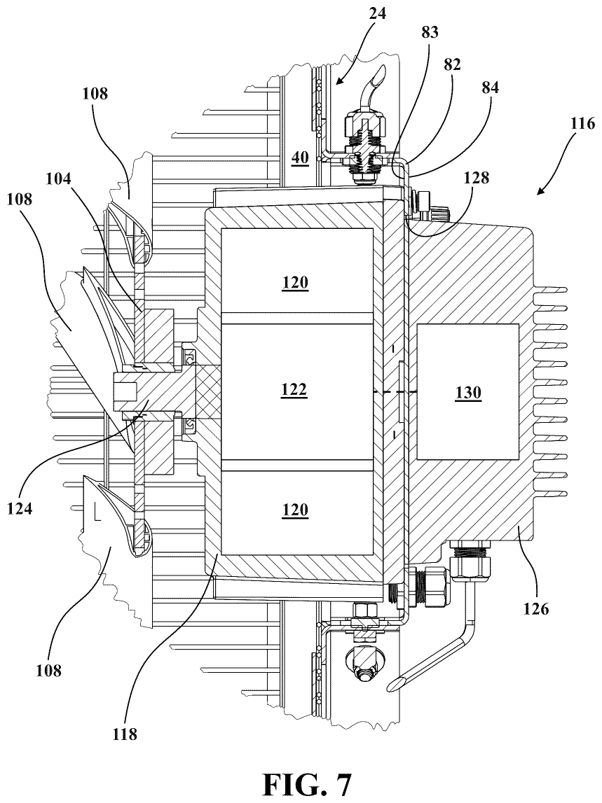

The HVLS fan 20 also includes the motor assembly 116 which is mounted to the mounting plate 82 of the rear cage section 32 of the cage housing 24. As best shown in FIGS. 5-7, the mounting plate 82 has an interior surface 83 facing the housing interior 40 and an exterior surface 84 opposite the interior surface 83. The motor assembly 116 includes a motor housing portion 118 disposed in the housing interior 40 and coupled to the interior surface 83 of the mounting plate 82. The motor housing portion 118 may be coupled to the interior surface 83 of the mounting plate 82 using fasteners or the like. The motor assembly 116 also includes a stator 120, a rotor 122, and a motor shaft 124. The stator 120 is disposed in the motor housing portion 118 (illustrated schematically in FIG. 7), and the rotor 122 is disposed in the in the motor housing portion 118 (also illustrated schematically in FIG. 7) and is configured for rotation about the central axis CA in response to energization of the stator 120. The motor shaft 124 is coupled to the rotor 122 and the central hub 104 of the fan assembly 100 such that the fan assembly 100 rotates about the central axis CA in response to rotation of the rotor 122. In some examples, the motor shaft 124 may be directly coupled to the central hub 104. In other examples, a geartrain is interposed between the motor shaft 124 and the central hub 104 for operatively coupling the motor shaft 124 to the central hub 104. The geartrain may have a specific gear ratio selected to modify the speed and/or torque provided by the motor shaft 124 and transmitted to the central hub 104 to rotate the plurality of airfoils 108 about the central axis CA.

The configurations of the stator 120 and the rotor 122 are not necessarily limited for the purposes of this disclosure. In one example, the rotor 122 may be an external rotor shaped to at least partially surround the stator 120. In other words, the stator 120 may be at least partially disposed within the rotor 122. The rotor 122 may include a base member and a plurality of magnets coupled to the base member (e.g., spaced radially and distributed circumferentially about the central axis CA). The stator 120 may include electrical windings configured to be energized to electromagnetically interact with the plurality of magnets of the rotor 122 to effectuate rotation of the rotor 122 relative to the stator 120 to rotate the central hub 104 and the plurality of airfoils 108 about the central axis CA. Overall, the stator 120 and the rotor 122 together may constitute any suitable form of electric motor such as a brushless direct current (BLDC) motor, a brushed DC motor, an AC induction motor, an AC synchronous motor, a switched reluctance motor, or any other electric motor configuration suitable to drive the fan assembly 100 about the central axis CA. One exemplary configuration of a motor assembly is described in U.S. Pat. No. 11,168,699, granted Nov. 9, 2021 and assigned to I.M.E INDUSTRIA MOTORI ELETTRICI S.P.A., the contents of which is incorporated by reference herein in its entirety. Other configurations of the stator 120 and the rotor 122 are contemplated.

The motor assembly 116 also includes a controller housing portion 126 extending from the motor housing portion 118 beyond the exterior surface 84 of the mounting plate 82 such that the controller housing portion 126 is at least partially disposed outside of the housing interior 40 of the cage housing 24. While a variety of configurations for arranging the controller housing portion 126 relative to the motor housing portion 118 and the mounting plate 82 are contemplated, in the illustrated configuration, the mounting plate 82 defines a central void 128 extending between the interior surface 83 and the exterior surface 84, and the controller housing portion 126 extends through the central void 128 such that the controller housing portion 126 is at least partially disposed outside of the housing interior 40 of the cage housing 24. More specifically, as best shown in FIGS. 5 and 7, the controller housing portion 126 is coupled to the motor housing portion 118 such that the controller housing portion 126 is cantilevered from the motor housing portion 118 through the central void 128 of the mounting plate 82. Accordingly, in the illustrated configuration, the controller housing portion 126 is not directly coupled to the mounting plate 82 and is instead solely supported relative to the motor housing portion 118. Advantageously, by supporting the controller housing portion 126 and the motor housing portion 118 as a single unit relative to the mounting plate 82, the ease of assembly and maintenance of the HVLS fan 20 is improved. More specifically, because the controller housing portion 126 and the motor housing portion 118 are mounted as a single unit relative to the mounting plate 82, this entire assembly can be more easily removed or installed. This is particularly advantageous for maintenance purposes given that such components may require regular maintenance over their operational life. Furthermore, by virtue of the controller housing portion 126 being at least partially disposed outside of the housing interior 40 of the cage housing 24, the controller housing portion 126 is exposed to additional airflow during rotation of the fan assembly 100, improving the cooling of the motor assembly 116 (and, as a result, the longevity/performance of the motor assembly 116).

As illustrated schematically in FIG. 7, the motor assembly 116 further includes an onboard controller 130 (also sometimes referred to as a “driver”) in communication with the stator 120 for selectively controlling energization of the stator 120. The onboard controller 130 may include a processor or the like as well as power electronics for converting and directing power from a power source to the motor assembly 116. The onboard controller 130 is disposed in the controller housing portion 126 such that the onboard controller 130 is external to the cage housing 24. Operation of the motor assembly 116 (particularly, energization of the stator 120) may be programmable/adjustable via the onboard controller 130 to vary the volume and/or speed of air being moved by the fan assembly 100. For example, a number of parameters may be adjustable via the onboard controller 130 including, but not limited to, speed, torque, amperage, voltage, the like, or a combination thereof. The HVLS fan 20 may also include a user interface 132 (e.g. one or more buttons, knobs, switches, dials, touchscreens, or other human-machine interfaces) arranged for user engagement and in communication with the onboard controller 130 to effectuate adjustment of energization of the stator 120 via the onboard controller 130. As best shown in FIG. 5, for example, the user interface 132 may be implemented as a speed control dial 132 coupled to the mounting plate 82 and arranged for user engagement to adjust the speed at which the onboard controller 130 operates the motor assembly 116 to rotate the fan assembly 100. In other examples, the user interface 132 may even be located remotely from the HVLS fan 20, such as a touchscreen, switch, or other human-machine interface disposed on a wall remote from the HVLS fan 20 or the like. Other configurations of a user interface 132 are contemplated.

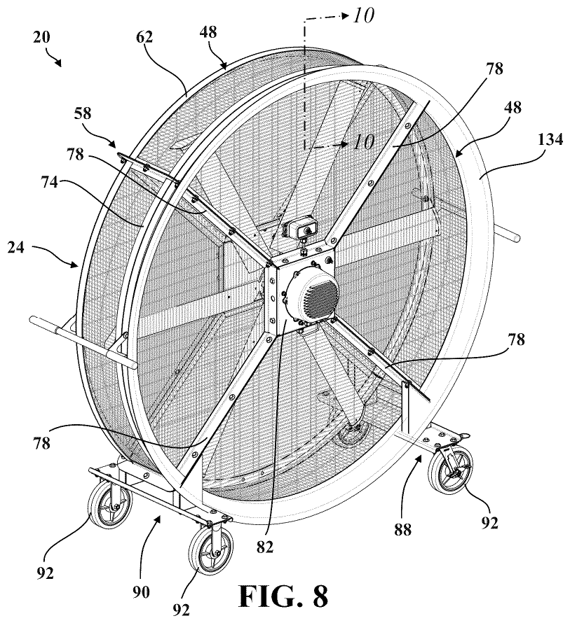

Referring to FIGS. 8-10, although not required, the HVLS fan 20 may also include an orifice ring 134 that is coupled to, or integrally formed with, the rear cage section 32 of the cage housing 24. In one example, the orifice ring 134 is coupled to, or integrally formed with the rear frame ring 74 of the rear cage section 32 of the cage housing 24, but other configurations are contemplated. The orifice ring 134 extends outwardly away from the rear cage section 32 in a direction away from the front cage section 28. The orifice ring 134 extends from an inward end 136 coupled to the cage housing 24 to a flared outward end 138 and defines an inner surface 140 and an opposing outer surface 142 that extend substantially parallel to one another along a first length L1 and curve away from the central axis CA for a second length L2 to the flared outward end 138. Preferably, the curvature α of each of the inner surface 140 and the outer surface 142 is constant along the second curved length L2. The inner surface 140 and the opposing outer surface 142 may each terminate at the flared outward end 138 at an outer ring 144 that extends radially relative to the central axis CA. The inner surface 140 of said orifice ring 134 has a first diameter D1 along the first length L1. Although not required, the first diameter D1 of the inner surface 140 of said orifice ring 134 is typically less than the inner diameter ID of the cylindrical cage section 36.

Where included, the orifice ring 134 provides significant advantages over fans that do not include an orifice ring 134. In particular, the orifice ring 134 functions to control the airflow and direction (collectively shown by arrow AF2) exiting the front cage section 28 of the HVLS fan 20 based on a given airflow (shown by arrow AF1) entering the HVLS fan 20 at the rear cage section 32. In particular, by constricting the airflow AF1 entering the HVLS fan 20 at the rear cage section 32, the orifice ring 134 can increase the velocity of the airflow AF2 exiting the HLVS fan 20 at the front cage section 28 at a given input airflow AF1 at the rear cage section 32, thus improving the throw distance and focus of the airflow AF2. This is particularly relevant in applications where airflow AF2 needs to be directed over a specific area or distance in proximity to the front cage section 28.

In addition, the orifice ring 134 can reduce turbulence at the front cage section 28 of the HVLS fan 20, leading to a more efficient operation. In particular, by smoothing out the airflow AF2, the orifice ring 134 minimizes energy loss due to chaotic air movement, thereby enhancing the overall efficiency of the HVLS fan 20. Still further, by controlling the airflow AF2 pattern, the orifice ring 134 can help in reducing noise. Turbulent airflow is a significant source of noise in HVLS fans, and by guiding the air to move smoothly through the front cage section 28, the orifice ring 134 can dampen noise. Yet still further, the orifice ring 134 stabilizes the airflow AF2 leaving through the front cage section 28 of the HVLS fan 20, preventing the air stream from dispersing too quickly or unevenly. This stabilization can lead to more consistent air distribution, which is important in applications for cooling large spaces. Even still further, in fan systems where maintaining or managing pressure is critical, the orifice ring 134 can help in balancing the pressure between the HVLS fan 20 and the surrounding environment that the HVLS fan 20 operates within its designs parameters, avoiding issues like back pressure.

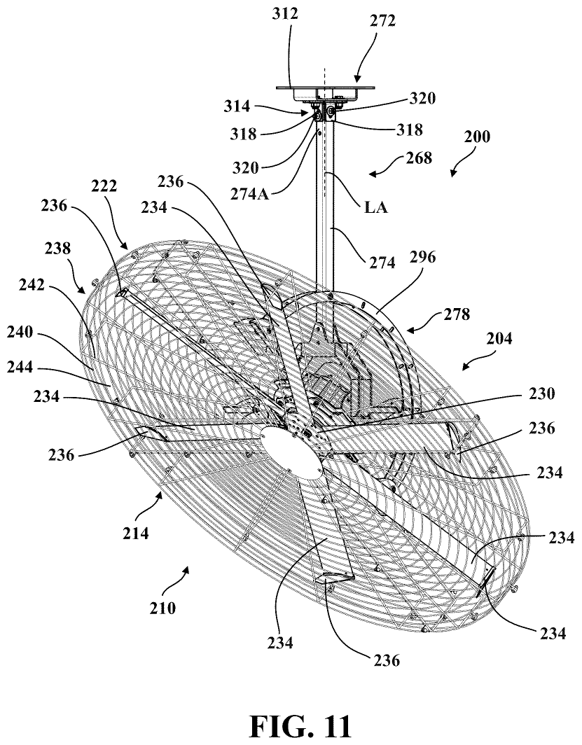

The present disclosure is also directed to a directional fan system 200 including a directional fan assembly 204 and a mounting assembly 268 for supporting the directional fan assembly 204 relative to a mounting structure. The mounting structure may be a ceiling mounting structure 206 or a wall or column mounting structure 208. Referring to FIGS. 11-19, the directional fan assembly 204 includes a cage housing 210. The cage housing 210 generally includes a front cage section 214, a rear cage section 218 spaced from the front cage section 214 along a central axis CA, and a cylindrical cage section 222 disposed annularly about the central axis CA and between the front cage section 214 and the rear cage section 218 such that the front cage section 214, the rear cage section 218, and the cylindrical cage section 222 cumulatively define a housing interior 226.

The directional fan assembly 204 also includes a central hub 230 supported for rotation about the central axis CA and a plurality of airfoils 234 coupled to and distributed circumferentially about the central hub 230 for rotation about the central axis CA with the central hub 230. The central hub 230 and the plurality of airfoils 234 are disposed in the housing interior 226 of the cage housing 210 for rotation about the central axis CA. During operation, rotation of the central hub 230 and the plurality of airfoils 234 about the central axis CA draws air through the rear cage section 218 and directs the air through the housing interior 226 and out of the front cage section 214 while the cage housing 210 inhibits inadvertent contact with the central hub 230 and the plurality of airfoils 234. Each airfoil 234 of the plurality of airfoils 234 is typically formed out of a lightweight material such as aluminum or a composite that can be formed into an airplane wing type shape with a hollow core. However, it should be appreciated that the plurality of airfoils 234 can be formed of a variety of different materials, including plastics, polyurethanes, and other suitably rigid materials adequate to form an airfoil, or even combinations of such materials known to those skilled in the art. It should also be appreciated that the length of each airfoil 234 of the plurality of airfoils 234 relative to the central axis CA can be increased or decreased to suit a certain application. Generally, the diameter of the plurality of airfoils 234 is less than an inner diameter of the cylindrical cage section 222, but the gap between the plurality of airfoils 234 and the inner diameter of the cylindrical cage section 222 can vary depending on the application. Although not required, each airfoil 234 of the plurality of airfoils 234 can further include a wingtip fence 236 for conditioning airflow near a radially outer end of each airfoil 234. Each wingtip fence 236 may extend generally transverse to its corresponding airfoil 234 and may be formed as integral portions of the airfoil 234 or as separate components secured thereto. Other configurations of wingtip fences 236 are contemplated.

The cage housing 210 may have any construction suitable for permitting airflow therethrough and inhibiting inadvertent contact with the central hub 230 and the plurality of airfoils 234. For example, the front cage section 214, the rear cage section 218, and the cylindrical cage section 222 of the cage housing 210 generally include a wire grid structure 238. The wire grid structure 238 may include multiple pluralities of wires 240, 242 arranged relative to each other to define grid openings 244 that permit airflow therethrough. In the illustrated configuration, the wire grid structure 238 has a polar arrangement with a first plurality of wires 240 extending circumferentially about the central axis CA and a second plurality of wires 242 extending radially relative to the central axis CA to define the wire grid structure 238. In other examples, the wire grid structure 238 may have a rectilinear arrangement with the first plurality of wires 240 extending in a first direction and the second plurality of wires 242 extending in a second direction transverse to the second direction to define the wire grid structure 238. The first and second plurality of wires 240, 242 may be spaced relative to each other at any suitable distance for the application. The respective size and shape of the grid openings 244 may differ depending on the desired airflow of the directional fan assembly 204 during operation and is dictated by the respective distance between adjacent wires of the first and second plurality of wires 240, 242. In some examples, the cylindrical cage section 222 may be formed without openings, such as from sheet metal or the like.

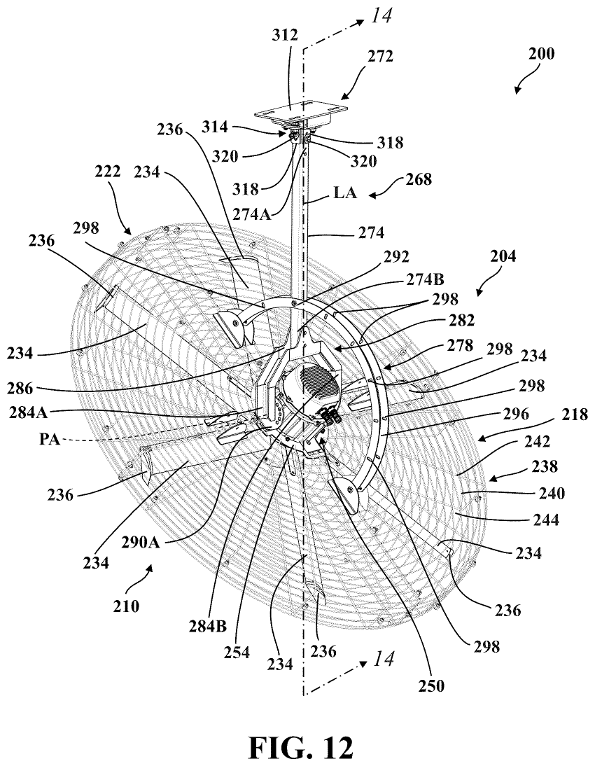

The directional fan assembly 204 further includes a motor assembly 250 including a motor shaft 252 coupled to the central hub 230 such that the central hub 230 and the plurality of airfoils 234 rotate about the central axis CA in response to rotation of the motor shaft 252. It should be appreciated that while the motor assembly 250 may be mounted in a manner similar to the motor assembly 116 as described above in the context FIGS. 1-7, the motor assembly 250 is not required to be mounted in the same manner and other configurations are contemplated. As best shown in FIGS. 12, 14, 15, and 19, the rear cage section 218 includes a mounting plate 254. The motor assembly 250 is coupled to the mounting plate 254 of the rear cage section 218. The mounting plate 254 may be generally annular and have a central opening 255 through which the motor shaft 252 is operatively coupled to the central hub 230 to support the central hub 230 and the plurality of airfoils 234 for rotation about the central axis CA in response to rotation of the motor shaft 252. In the illustrated configuration, the motor assembly 250 is coaxial with the central axis CA, but other configurations are contemplated. As described in further detail below, the mounting plate 254 is also configured to interface with the mounting assembly 268 to support the directional fan assembly 204 relative to a mounting structure.

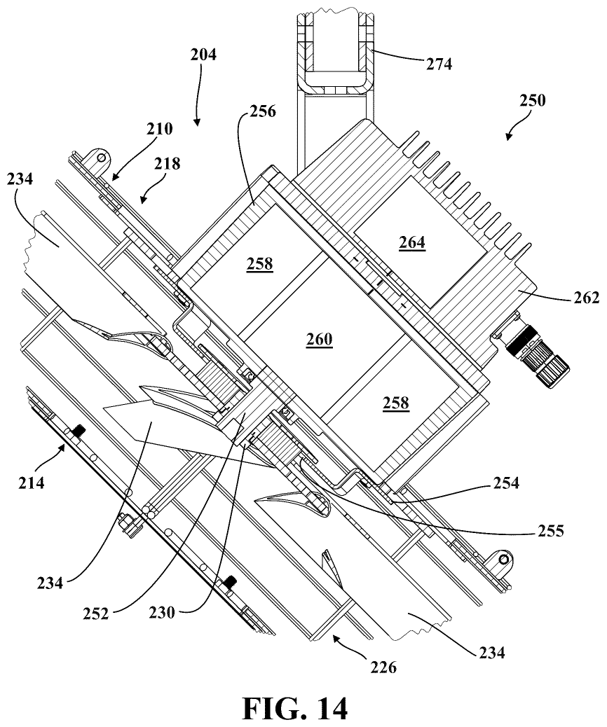

Similar to as described above in the context of FIGS. 1-7, the motor assembly 250 illustrated in FIGS. 11-19 includes a motor housing portion 256 coupled to the mounting plate 254 (e.g. via fasteners or the like). The motor assembly 250 also includes a stator 258 disposed in the motor housing portion 256 (illustrated schematically in FIG. 14), a rotor 260 disposed in the motor housing portion 256 (also illustrated schematically in FIG. 14) and configured for rotation about the central axis CA in response to energization of the stator 258. The motor shaft 252 is coupled to the rotor 260 and the central hub 230 such that the central hub 230 and the plurality of airfoils 234 rotate about the central axis CA in response to rotation of the rotor 260. In some examples, the motor shaft 252 is directly coupled to the central hub 230. In other examples, a geartrain is interposed between the motor shaft 252 and the central hub 230 for operatively coupling the motor shaft 252 to the central hub 230. The geartrain may have a specific gear ratio selected to modify the speed and/or torque provided by the motor shaft 252 and transmitted to the central hub 230 to rotate the plurality of airfoils 234 about the central axis CA.

The configurations of the stator 258 and the rotor 260 are not necessarily limited for the purposes of this disclosure. In one example, the rotor 260 may be an external rotor shaped to at least partially surround the stator 258. In other words, the stator 258 may be at least partially disposed within the rotor 260. The rotor 260 may include a plurality of magnets (e.g., spaced radially and distributed circumferentially about the central axis CA). The stator 258 may include electrical windings configured to be energized to electromagnetically interact with the plurality of magnets of the rotor 260 to effectuate rotation of the rotor 260 relative to the stator 258 to rotate the central hub 230 and the plurality of airfoils 234 about the central axis CA. Overall, the stator 258 and the rotor 260 together may constitute any suitable form of electric motor such as a brushless direct current (BLDC) motor, a brushed DC motor, an AC induction motor, an AC synchronous motor, a switched reluctance motor, or any other electric motor configuration suitable to drive the central hub 230 and the plurality of airfoils 234 about the central axis CA. One exemplary configuration of a motor assembly is described in U.S. Pat. No. 11,168,699, granted Nov. 9, 2021 and assigned to I.M.E INDUSTRIA MOTORI ELETTRICI S.P.A., the contents of which is incorporated by reference herein in its entirety. Other configurations of the stator 258 and the rotor 260 are contemplated.

The motor assembly 250 also includes a controller housing portion 262 extending from the motor housing portion 256. While a variety of configurations for arranging the controller housing portion 262 relative to the motor housing portion 256 and the mounting plate 254 are contemplated, in the illustrated configuration, the controller housing portion 262 is coupled to the motor housing portion 256 such that the controller housing portion 262 is cantilevered from the motor housing portion 256. Accordingly, in the illustrated configuration, the controller housing portion 262 is not directly coupled to the mounting plate 254 and is instead solely supported relative to the motor housing portion 256. Other configurations are contemplated. As illustrated schematically in FIG. 14, the motor assembly 250 further includes an onboard controller 264 in communication with the stator 258 for selectively controlling energization of the stator 258. The onboard controller 264 is disposed in the controller housing portion 262. Operation of the motor assembly 250 (particularly, energization of the stator 258) may be programmable/adjustable via the onboard controller 264 to vary the volume and/or speed of air being moved by directional fan assembly 204). For example, a number of parameters be adjustable via the onboard controller 264 including but not limited to speed, torque, amperage, voltage, the like, or a combination thereof.

As alluded to above, the directional fan system 200 includes a mounting assembly 268 for supporting the directional fan assembly 204 relative to a mounting structure (e.g. a ceiling mounting structure 206 or a wall or column mounting structure 208). The mounting assembly 268 generally includes an upper mounting bracket assembly 272 (described in further detail below) configured to be coupled to the mounting structure, an extension member 274 having a top portion 274A coupled to the upper mounting bracket assembly 272 and a bottom portion 274B, and a lower mounting bracket assembly 278 (described in further detail below) coupling the bottom portion 274B of the extension member 274 to the mounting plate 254 of the directional fan assembly 204. The extension member 274 may be an elongated hollow member having a central channel for routing power and/or control wires to the motor assembly 250. The extension member 274 may have a circular or square cross-sectional profile, but other cross-sectional profiles are contemplated. The extension member 274 may have a length sufficient to space the directional fan assembly 204 from the mounting structure to permit the directional fan assembly 204 to be arranged in a desired orientation via the upper mounting bracket assembly 272 and/or the lower mounting bracket assembly 278 (as described in further detail below). The extension member 274 may define or otherwise include features configured to cooperate with the upper mounting bracket assembly 272 and the lower mounting bracket assembly 278 to couple the extension member 274 to the upper mounting bracket assembly 272 and the lower mounting bracket assembly 278 such that the mounting assembly 268 supports the directional fan assembly 204 relative to the mounting structure.

The lower mounting bracket assembly 278 generally couples the directional fan assembly 204 to the bottom portion 274B of the extension member 274 and provides for adjustability of the central axis CA of the directional fan assembly 204 in at least one degree of freedom relative to the extension member 274 such that the airflow of the directional fan assembly 204 may be arranged in a desired orientation. The lower mounting bracket assembly 278 includes a yoke 282 having a first yoke arm 284A coupled to the mounting plate 254, a second yoke arm 284B coupled to the mounting plate 254 and spaced from the first yoke arm 284A, and a central yoke portion 286 coupled to and extending between the first yoke arm 284A and said second yoke arm 284B. The central yoke portion 286 is coupled to the bottom portion 274B of the extension member 274. Cumulatively, the first yoke arm 284A, the second yoke arm 284B, and the central yoke portion 286 of the yoke 282 define a U-shaped space within which the motor assembly 250 is disposed. The yoke 282 may be formed from individual components that are welded or otherwise coupled, or may be formed as an integral component. The yoke 282 is pivotably coupled to one of the mounting plate 254 and the bottom portion 274B of the extension member 274 such that the yoke 282 is pivotable about a pivot axis PA to adjust an orientation of the directional fan assembly 204.

FIGS. 11-13 and 18-19 illustrate one configuration of the lower mounting bracket assembly 278 where the yoke 282 is pivotably coupled to the mounting plate 254 such that the yoke 282 is pivotable about a pivot axis PA to adjust an orientation of the directional fan assembly 204. A variety of configurations of pivotably coupling the yoke 282 to the mounting plate 254 are contemplated. In the illustrated configuration, the lower mounting bracket assembly 278 further includes a first adjustment plate 290A interposed between the first yoke arm 284A and the mounting plate 254 and a second adjustment plate 290B interposed between the second yoke arm 284B and the mounting plate 254. Each of the first adjustment plate 290A and the second adjustment plate 290B define a plurality of adjustment holes 294 spaced radially from and distributed circumferentially about the pivot axis PA. The plurality of adjustment holes 294 define a plurality of predefined orientations of the yoke 282 relative to the mounting plate 254. In these configurations, the lower mounting bracket assembly 278 further includes a fastener 292 disposable through a selected adjustment hole 294 of the plurality of adjustment holes 294 to retain the yoke 282 at one of the plurality of predefined orientations relative to the mounting plate 254. In some examples, the plurality of adjustment holes 294 may instead be realized as a slot providing infinite adjustability of the orientations of the yoke 282 relative to the mounting plate 254.

Although not required, in the configurations illustrated in FIGS. 11-13 and 18-19, the lower mounting bracket assembly 278 further includes a brace 296 extending from the rear cage section 218. The brace 296 may be configured to be coupled to extension member 274 to further stabilize the cage housing 210 relative to the extension member 274 during operation of the fan assembly 204 (e.g., to reduce vibration or deflection of the cage housing 210 due to the large volume of air being displaced by the fan assembly 204) and/or to further retain the yoke 282 at the predefined orientations relative to the mounting plate 254 defined by the plurality of adjustment holes 294 of the first adjustment plate 290A and the second adjustment plate 290B. More specifically, in the illustrated configuration, the brace 296 extends along an arc and defines a plurality of bracing holes 298 along the arc at a plurality of locations along the arc corresponding to the plurality of adjustment holes 294 of the first adjustment plate 290A and the second adjustment plate 290B. The extension member 274 defines a locking hole arranged to be aligned with one of the plurality of bracing holes 298 at each predefined orientation of the yoke 282 relative to the mounting plate 254 for receiving a fastener 292 through the locking hole to further retain the yoke 282 at the corresponding predefined orientation relative to the mounting plate 254. Other configurations of the brace 296 for further retaining the yoke 282 at the predefined orientations relative to the mounting plate 254 are contemplated.

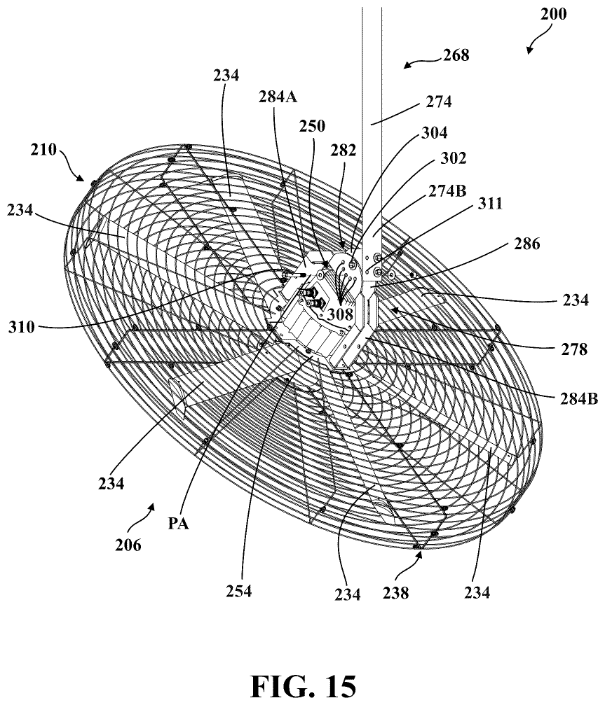

FIG. 15 illustrates another configuration of the lower mounting bracket assembly 278 where the yoke 282 is pivotably coupled to the bottom portion 274B of the extension member 274 such that the yoke 282 is pivotable about a pivot axis PA to adjust an orientation of the directional fan assembly 204. A variety of configurations of coupling the yoke 282 to the bottom portion 274B of the extension member 274 in an adjustable manner are contemplated. In the illustrated version, the bottom portion 274B of the extension member 274 defines a pivot point 302 defining the pivot axis PA. Here, the pivot point 302 is defined by a pivot member 304 extending from the bottom portion 274B of the extension member 274, but other configurations are contemplated. For example, the pivot point 302 may be defined by the bottom portion 274B of the extension member 274 itself (i.e., without the intermediate pivot member 304 component). Here, the central yoke portion 286 of the yoke 282 is coupled to the pivot point 302 and pivotable about the pivot axis PA. For example, a fastener 306 may extend through the central yoke portion 286 of the yoke 282 and the pivot point 302 to couple the yoke 282 to the bottom portion 274B of the extension member 274 such that the yoke 282 (and, thus, the directional fan assembly 204) is pivotable about the pivot axis PA to orient the airflow of the directional fan assembly 204 in a desired direction.

Still referring to FIG. 15, in the illustrated configuration, the central yoke portion 286 of the yoke 282 defines a plurality of adjustment holes 308 spaced radially from and distributed partially circumferentially about the pivot axis PA. The plurality of adjustment holes 308 may define a plurality of predefined orientations of the yoke 282 (and, thus, the directional fan assembly 204) relative to the bottom portion 274B of the extension member 274. Here, a fastener 310 may be disposed through one of the plurality of adjustment holes 308 and through a constraining point 311 defined by the bottom portion 274B of the extension member 274 or the pivot member 304 to retain the yoke 282 at one of the plurality of predefined orientations relative to the bottom portion 274B of the extension member 274. In some examples, the plurality of adjustment holes 308 may be realized as a slot providing infinite adjustability of the orientations of the yoke 282 (and, thus, the directional fan assembly 204) relative to the bottom portion 274B of the extension member 274.

The lower mounting bracket assembly 278 provides for adjustability of the directional fan assembly 204 about the pivot axis PA (e.g. permitting the directional fan assembly 204 to be oriented up or down). In some configurations, it may be desired to limit the orientation of the central axis CA of the directional fan assembly 204 to 45 degrees or less relative to horizontal for optimal performance/targeted airflow in a desired direction within a facility (generally downward toward occupants of the facility). Additional degrees of freedom of adjustability of the directional fan assembly 204 are contemplated. For example, at least a portion of the extension member 274 may also be rotatable and/or adjustable about a longitudinal axis LA extending along a length of said extension member 274 for adjusting the orientation of the directional fan assembly 204 in a second degree of freedom transverse to the pivot axis PA (e.g. in addition to the up or down adjustability provided by the lower mounting bracket assembly 278, adjustability left or right is also provided). It should be appreciated that the configurations of the lower mounting bracket assembly 278 illustrated herein are illustrative examples and other configurations for coupling the directional fan assembly 204 to the bottom portion 274B of the extension member 274 are contemplated. Furthermore, other configurations of providing adjustability of the orientation of the central axis CA of the directional fan assembly 204 in additional degrees of freedom are contemplated. Other configurations for coupling the directional fan assembly 204 to the bottom portion 274B of the extension member 274 are also contemplated.

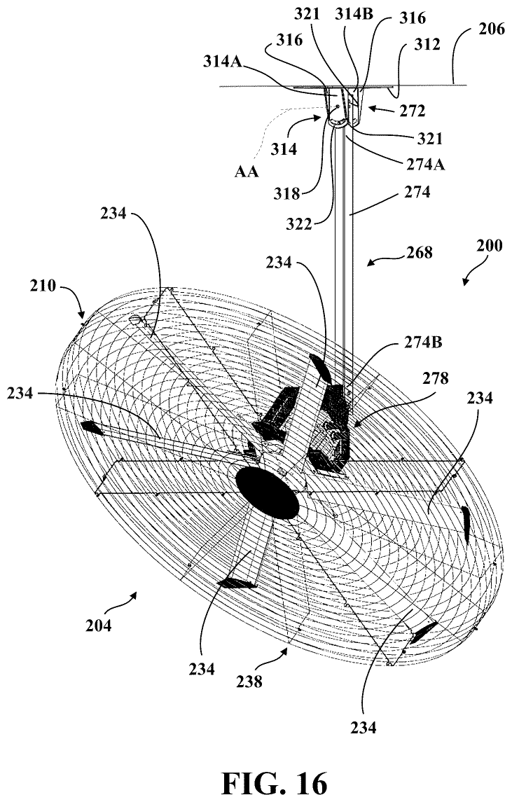

As alluded to above, the mounting assembly 268 also includes an upper mounting bracket assembly 272 configured to be coupled to the mounting structure (e.g. a ceiling mounting structure 206 or a wall or column mounting structure 208). FIGS. 11-17I illustrate versions of the directional fan system 200 a mounting assembly 268 configured to support the directional fan assembly 204 relative to a ceiling mounting structure 206. The ceiling mounting structure 206 may be a joist or other suitable ceiling component for supporting the directional fan system 200. The upper mounting bracket assembly 272 generally couples the top portion 274A of the extension member 274 to the ceiling mounting structure 206. FIGS. 11-13 illustrate one exemplary version of the upper mounting bracket assembly 272 according to the present disclosure. Here, the upper mounting bracket assembly 272 includes a top plate 312 configured to be coupled to the ceiling mounting structure 206 via fasteners or the like. The upper mounting bracket assembly 272 further includes a pair of adjustment brackets 314 extending transversely (i.e., downward) from the top plate 312. Although not required, the upper mounting bracket assembly 272 may further include gussets 316 extending between the top plate 312 and each of the adjustment brackets 314 to strengthen the pair of adjustment brackets 314 against lateral deflection (see FIG. 16). The pair of adjustment brackets 314 may each define a corresponding coaxial bore 318. The top portion 274A of the extension member 274 may be coupled to the pair of adjustment brackets 314 (e.g., via one or more fasteners 320 extending through the coaxial bores 318). In some examples, the pair of adjustment brackets 314 may define features to rigidly couple the top portion 274A of the extension member 274 to the pair of adjustment brackets 314. For example, the pair of adjustment brackets 314 may define two or more pairs coaxial bores 318 each of which may be configured to receive fasteners 320 disposed through two or more pairs coaxial bores 318 and engaging constraining points 321 defined by the top portion 274A of the extension member 274 to retain the extension member 274 at a predefined angular orientation relative to the upper mounting bracket assembly 272. In the configuration illustrated in FIGS. 11-13, the extension member 274 extends substantially transversely from the top plate 312, but other predefined angular orientations are contemplated.

In some examples, the upper mounting bracket assembly 272 provides for adjustability of the longitudinal axis LA of the extension member 274 relative to top plate 312 in at least one degree of freedom. A variety of such configurations of the upper mounting bracket assembly 272 are contemplated. For example, referring to FIG. 16, the coaxial bores 318 may cumulatively define an adjustment axis AA and the top portion 274A of the extension member 274 may be coupled to the upper mounting bracket assembly 272 such that the extension member 274 is pivotable about the adjustment axis AA. Still referring to FIG. 16, the pair of adjustment brackets 314 may each further define an adjustment slot 322. The adjustment slot 322 may be arcuate and be radially spaced from and extend partially circumferentially around the adjustment axis AA. Here, one or more fasteners may be disposed through the adjustment slot 322 and engage constraining points 321 defined by the top portion 274A of the extension member 274 to retain the extension member 274 at a desired orientation relative to the top plate 312 of the upper mounting bracket assembly 272.

In some examples, the adjustment slot 322 of the upper mounting bracket assembly 272 may provide for self-leveling of the fan system 200. For example, once the lower mounting bracket assembly 278 is coupled to the directional fan assembly 204 and oriented relative to the bottom portion 274B of the extension member 274 as desired for the application, an installer may allow the extension member 274 and the directional fan assembly 204 to pivot about the adjustment axis AA of the upper mounting bracket assembly 272 without outside force until the extension member 274 and the directional fan assembly 204 reach a point of static equilibrium. For example, the extension member 274 and the directional fan assembly 204 may pivot about the adjustment axis AA of the upper mounting bracket assembly 272 without outside force until a center of gravity of the extension member 274 and the directional fan assembly 204 is arranged below the adjustment axis. Once the extension member 274 and the directional fan assembly 204 reach the point of static equilibrium, the installer may dispose the one or more fasteners through the adjustment slot 322 and engage the constraining points 321 defined by the top portion 274A of the extension member 274 to retain the extension member 274 at the point of static equilibrium. Advantageously, by retaining the extension member 274 at the point of static equilibrium, moment forces about the upper mounting bracket assembly 272 are minimized/eliminated, allowing the directional fan assembly 204 to be mounted with minimal stress on the mounting assembly 268.

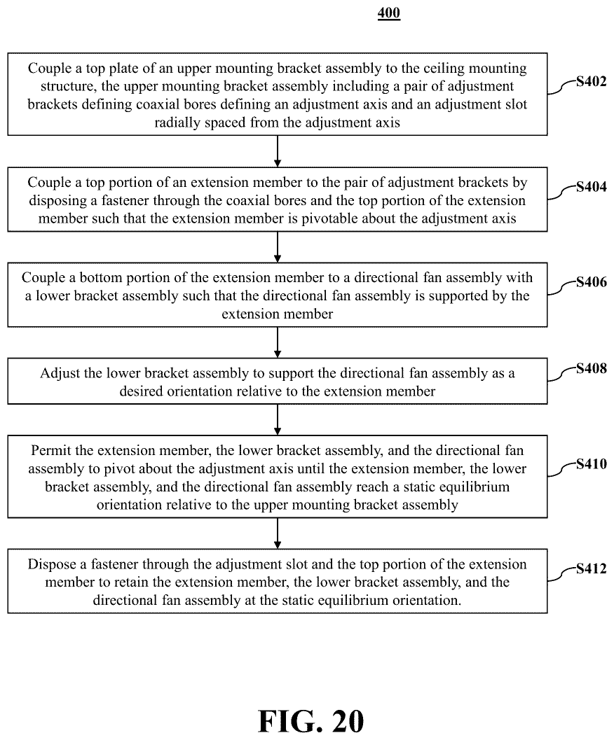

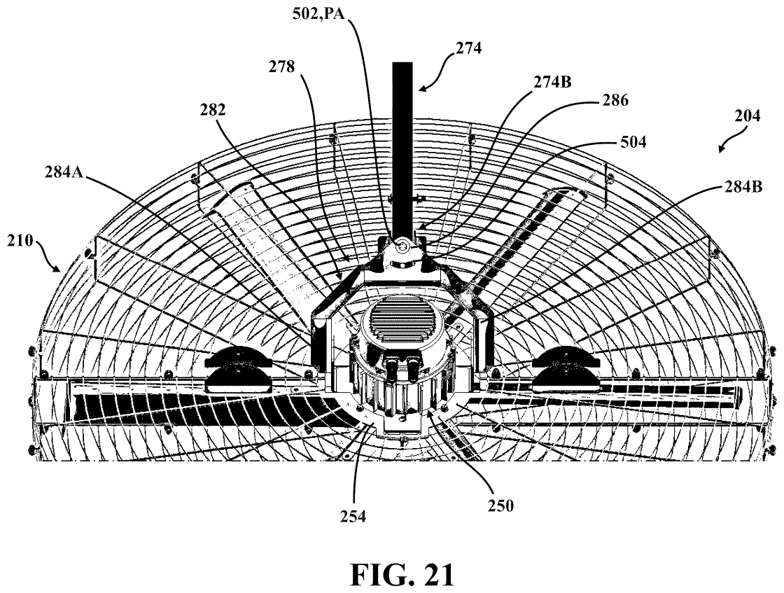

Accordingly, referring to FIG. 20, the present disclosure is also directed to a method 400 of mounting a directional fan assembly 204 to a ceiling mounting structure 206. The method includes a step S402 of coupling the top plate 312 of the upper mounting bracket assembly 272 to the ceiling mounting structure 206. As described above, the upper mounting bracket assembly 272 includes the pair of adjustment brackets 314 defining coaxial bores 318 defining an adjustment axis AA and the adjustment slot 322 radially spaced from the adjustment axis AA. The method 400 also includes a step S404 of coupling the top portion 274A of the extension member 274 to the pair of adjustment brackets 314 by disposing a fastener 320 through the coaxial bores 318 and the top portion 274A of the extension member 274 such that the extension member 274 is pivotable about the adjustment axis AA. The method 400 also includes a step S406 of coupling a bottom portion 274B of the extension member 274 to the directional fan assembly 204 with the lower mounting bracket assembly 278 such that the directional fan assembly 204 is supported by the extension member 274. The method 400 also includes a step S408 of adjusting the lower mounting bracket assembly 278 to support the directional fan assembly 204 at a desired (i.e., user-selected) orientation relative to the extension member 274. The method 400 also includes a step S410 of permitting the extension member 274, the lower mounting bracket assembly 278, and the directional fan assembly 204 to pivot about the adjustment axis AA until the extension member 274, the lower mounting bracket assembly 278, and the directional fan assembly 204 reach a static equilibrium orientation relative to the upper mounting bracket assembly 272. The method 400 also includes a step S412 of disposing a fastener through the adjustment slot 322 and the top portion 274A of the extension member 274 to retain the extension member 274, the lower mounting bracket assembly 278, and the directional fan assembly 204 at the static equilibrium orientation. Of course, it should be appreciated that the steps of the method 400 recited above may be modified in view of the other structural arrangements disclosed herein.

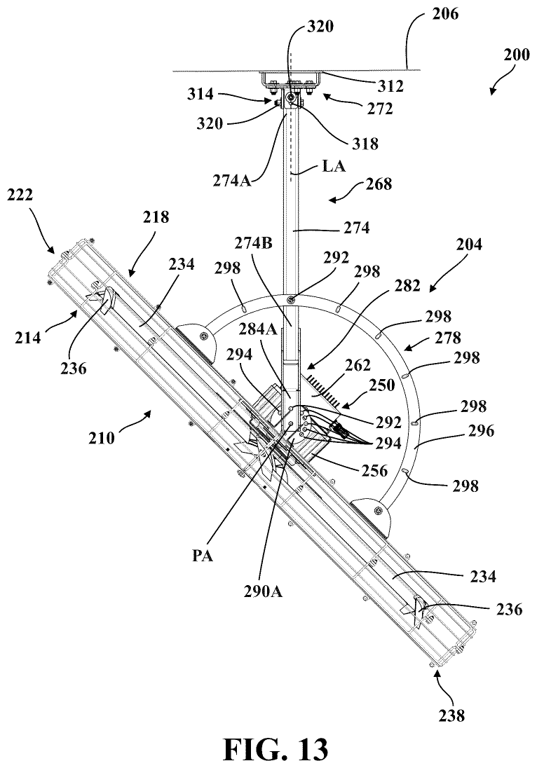

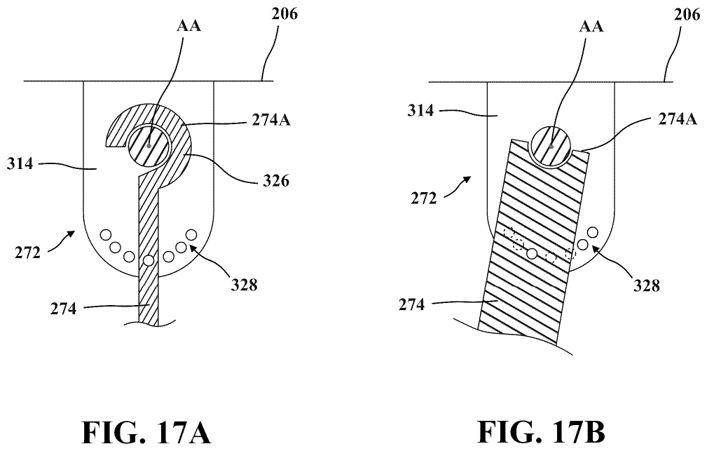

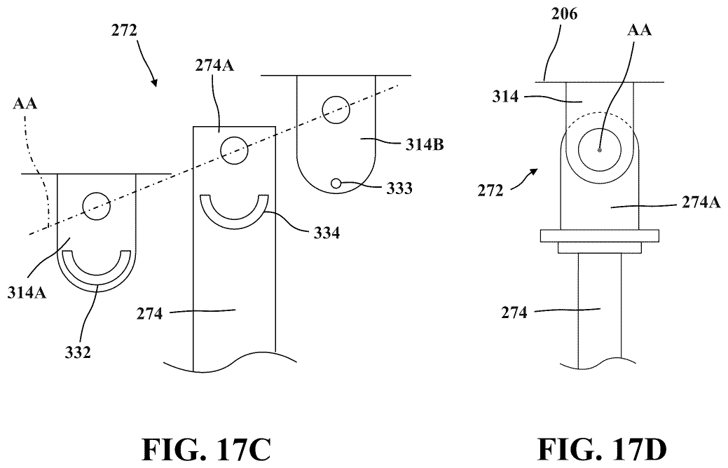

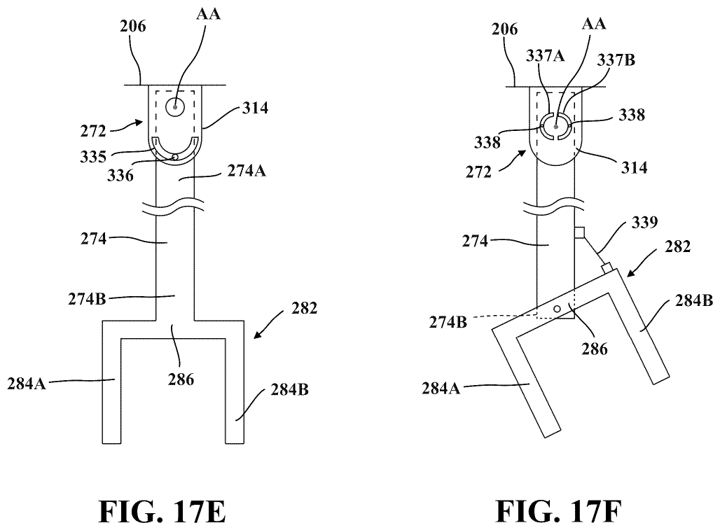

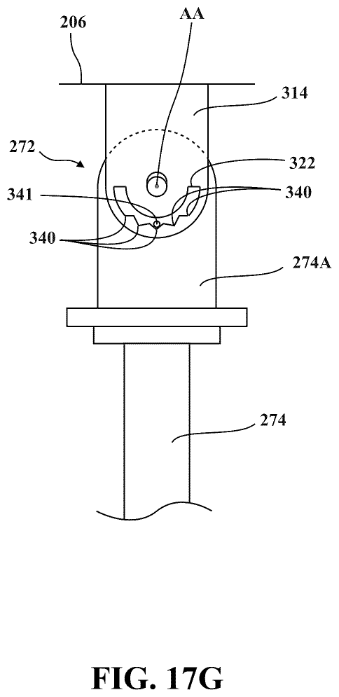

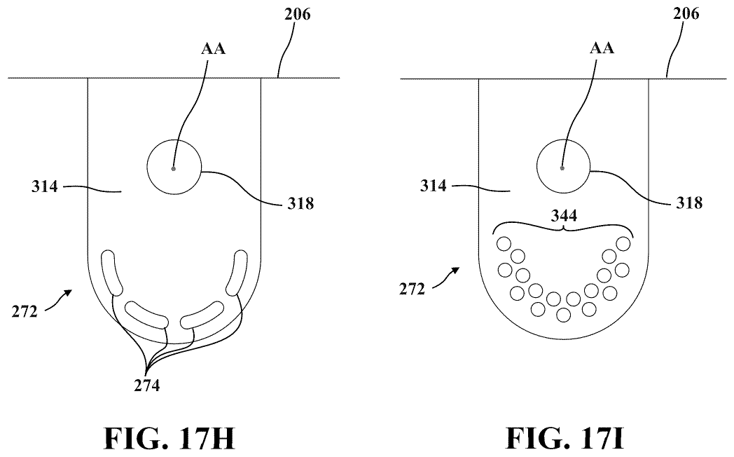

FIGS. 13A-13I schematically illustrate a variety of other exemplary configurations of the upper mounting bracket assembly 272 and top portion 274A of the extension member 274 according to the present disclosure. FIGS. 17A and 17B show alternative configurations of the top portion 274A of the extension member 274 defined to pivot about a shaft or fastener of the upper mounting bracket assembly 272. In FIG. 17A, the top portion 274A of the extension member 274 defines a hook 326 configured to engage the shaft or fastener of the upper mounting bracket assembly 272 such that the extension member 274 is pivotable about the adjustment axis AA defined by the shaft or fastener. In FIG. 17B, the top portion 274A of the extension member 274 defines a half circle configured to abut the shaft or fastener and pivot about the adjustment axis AA. Here, the half circle does not bear any downward load, instead merely constraining pivoting of the extension member 274 about the adjustment axis AA. In both FIGS. 17A and 17B, a pin or fastener is configured to be disposed through one of a plurality of adjustment holes 328 of the upper mounting bracket assembly 272 to constrain rotation of the extension member 274 about the adjustment axis AA. In FIG. 17C, the upper mounting bracket assembly 272 includes a first adjustment bracket 314A defining an adjustment slot 332 and a second adjustment bracket 314B defining an adjustment hole 333. Here, the top portion 274A of the extension member 274 defines a corresponding slot 334. A fastener or pin may be configured to be disposed through one of the adjustment slot 332 and the adjustment hole 333 of the upper mounting bracket assembly 272 and through the corresponding slot 334 of the top portion 274A of the extension member 274 to constrain rotation of the extension member 274 about the adjustment axis AA. FIG. 17D shows a configuration where this is no constraint of rotation of the extension member 274 about the adjustment axis AA. FIG. 17E shows a configuration where the extension member 274 is formed integrally with the yoke 282 of the lower mounting bracket assembly 278. Here, a pin or fastener 336 is configured to be disposed through an adjustment slot 335 of the upper mounting bracket assembly 272 to constrain rotation of the extension member 274 about the adjustment axis AA. FIG. 17F shows a configuration where adjustment of the extension member 274 relative to the upper mounting bracket assembly 272 is defined by two co-axial arcuate slots 337A, 337B of the upper mounting bracket assembly 272, with a respective pin 338 configured to be disposed through each of the arcuate slots 337A, 337B to constrain rotation of the extension member 274 about the adjustment axis AA. In FIG. 17F, it is also contemplated that the yoke 282 may be constrained relative to the extension member 274 via a cable 339 or the like. FIG. 17G shows a configuration where the adjustment slot 322 of the upper mounting bracket assembly 272 defines a plurality of landings 340 configured to seat a pin or fastener 341 disposed though the upper mounting bracket assembly 272 and the extension member 274 to constrain rotation of the extension member 274 about the adjustment axis AA. FIG. 17H illustrates a configuration where the upper mounting bracket assembly 272 defines a plurality of arcuate slots 342 configured to receive a pin or fastener disposed though the upper mounting bracket assembly 272 and the extension member 274 to constrain rotation of the extension member 274 about the adjustment axis AA. FIG. 17I illustrates a configuration where the upper mounting bracket assembly 272 defines a plurality of holes 344 configured to receive a pin or fastener disposed though the upper mounting bracket assembly 272 and the extension member 274 to constrain rotation of the extension member 274 about the adjustment axis AA. Other configurations of the upper mounting bracket assembly 272 and top portion 274A of the extension member 274 are contemplated.

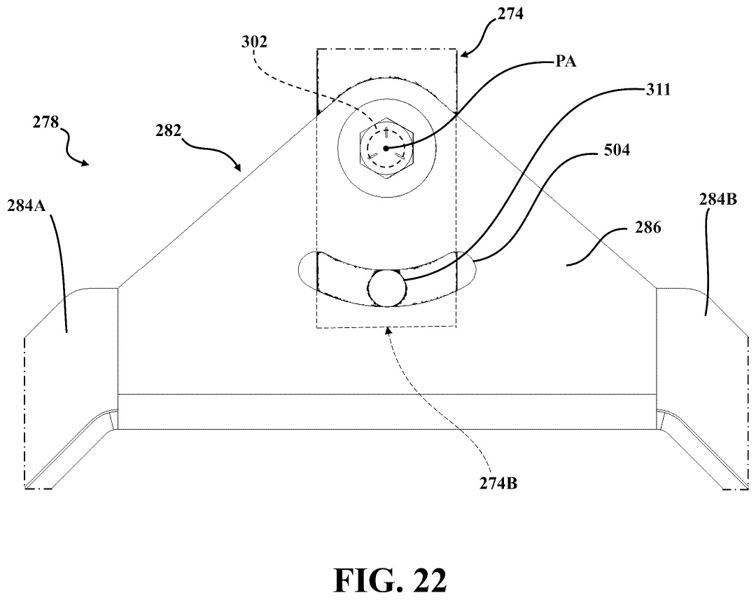

Referring to FIGS. 21 and 22, it is also contemplated that in addition to or instead of the self-leveling configurations of the upper mounting bracket assembly 272 described in FIGS. 16-17I, the lower mounting bracket assembly 278 may be configured to provide self-leveling functionality. As described above, the bottom portion 274B of the extension member 274 may define the pivot point 302 defining the pivot axis PA. In the configuration illustrated in FIGS. 21 and 22, the central yoke portion 286 of the yoke 282 is pivotably coupled to the bottom portion 274B of the extension member 274 (e.g. via a fastener 502) such that the yoke 282 is pivotable about the pivot axis PA to adjust an orientation of the directional fan assembly 204 and the yoke 282 relative to the extension member 274. Here, the central yoke portion 286 defines a slot 504 providing infinite adjustability of the orientations of the yoke 282 (and, thus, the directional fan assembly 204) relative to the bottom portion 274B of the extension member 274. Similar to as described above, a fastener may be disposed through the slot 504 and through the constraining point 311 defined by the bottom portion 274B of the extension member 274 to retain the yoke 282 at a desired orientation relative to the bottom portion 274B of the extension member 274. As alluded to above, this configuration could also provide self-leveling functionality. For example, similar to as described above in the context of FIG. 20, an installer may (i) install the upper mounting bracket assembly 272 and the extension member 274 at a desired orientation/location and couple the yoke 282 to the bottom portion 274B of the extension member 274, (ii) permit the yoke 282 and the directional fan assembly 204 to pivot about the pivot axis PA until the yoke 282 and the directional fan assembly 204 reach a static equilibrium orientation relative to the extension member 274, and (iii) dispose a fastener through the slot 502 and through the constraining point 311 defined by the bottom portion 274B of the extension member 274 to retain the yoke 282 and the directional fan assembly 204 at the static equilibrium orientation.

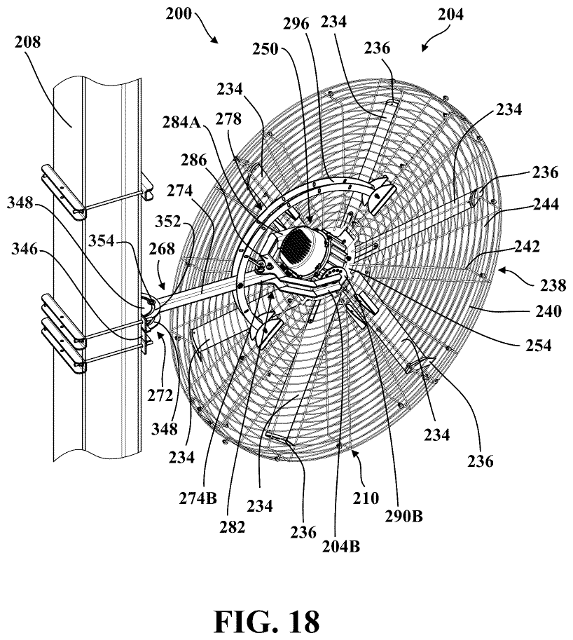

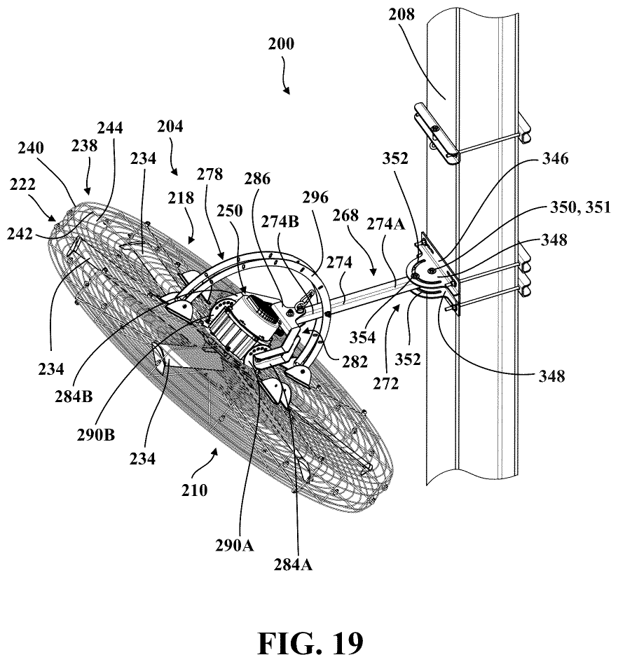

FIGS. 18 and 19 illustrate versions of the directional fan system 200 where the mounting assembly 268 is configured to support the directional fan assembly 204 relative to a wall or column mounting structure 208. The mounting assembly 268 of FIGS. 18 and 19 includes a lower mounting bracket assembly 278 configured to be mounted to the mounting plate 254 of the directional fan assembly 204, an upper mounting bracket assembly 272 configured to be mounted to the wall or column mounting structure 208, and an extension member 274 coupled to and extending between the upper mounting bracket assembly 272 and the lower mounting bracket assembly 278. The lower mounting bracket assembly 278 and the extension member 274 may be the same as the lower mounting bracket assembly 278 and the extension member 274 described above and thus duplicative description of the lower mounting bracket assembly 278 and extension member 274 have been omitted for brevity.

With continued reference to FIGS. 18 and 19, the upper mounting bracket assembly 272 generally couples the top portion 274A of the extension member 274 to the wall or column mounting structure 208. Here, the upper mounting bracket assembly 272 of FIGS. 18 and 19 includes one or more back plates 346 configured to be coupled to the wall or column mounting structure 208 via fasteners or the like. The upper mounting bracket assembly 272 of FIGS. 18 and 19 further includes a pair of mounting brackets 348 extending transversely (i.e., outward) from the back plate(s) 346. In some examples, the pair of mounting brackets 348 may define features to rigidly couple the top portion 274A of the extension member 274 to the pair of mounting brackets 348. For example, similar to as described above the mounting brackets 348 may define two or more pairs coaxial bores 350 each of which may be configured to receive fasteners 351 disposed through the two or more pairs coaxial bores 350 and engaging constraining points defined by the top portion 274A of the extension member 274 to retain the extension member 274 at a predefined angular orientation relative to the upper mounting bracket assembly 272.

In other configurations, such as illustrated in FIGS. 18 and 19, the upper mounting bracket assembly 272 is configured to provide adjustability of the orientation of the longitudinal axis LA of the extension member 274 in one or more degrees of freedom relative to the upper mounting bracket assembly 272. As shown in FIGS. 18 and 19, the mounting brackets 348 may define an adjustment slot 352 similar to as described above in the context of FIG. 15 to allow adjustability of the longitudinal axis LA of the extension member 274 relative to the upper mounting bracket assembly 272. In these configurations, the upper mounting bracket assembly 272 may further include at least one fastener 354 receivable through the adjustment slot 352 to retain the extension member 274 at a selected angular orientation relative to the back plate 346. Other configurations of providing adjustability of the orientation of the longitudinal axis LA of the extension member 274 relative to a wall or column mounting structure 208 in additional degrees of freedom are contemplated.

Several embodiments have been described in the foregoing description. However, the embodiments described herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular. It will be further appreciated that the terms “include,” “includes,” and “including” have the same meaning as the terms “comprise,” “comprises,” and “comprising.”

What is claimed is:

1. A high volume low speed fan comprising:
a cage housing including a front cage section, a rear cage section spaced from said front cage section along a central axis, and a cylindrical cage section disposed annularly about said central axis and between said front cage section and said rear cage section such that said front cage section, said rear cage section, and said cylindrical cage section cumulatively define a housing interior, wherein said rear cage section includes a mounting plate having an interior surface facing said housing interior and an exterior surface opposite said interior surface;
a fan assembly disposed in said housing interior of said cage housing, said fan assembly comprising:
a central hub supported for rotation about said central axis; and
a plurality of airfoils coupled to and distributed circumferentially about said central hub for rotation about said central axis with said central hub;
a motor assembly coupled to said mounting plate of said rear cage section of said cage housing, said motor assembly including:
a motor housing portion disposed in said housing interior and coupled to said interior surface of said mounting plate;
a stator disposed in said motor housing portion;
a rotor disposed in said motor housing portion and configured for rotation about said central axis in response to energization of said stator;
a motor shaft coupled to said rotor and said central hub of said fan assembly such that said fan assembly rotates about said central axis in response to rotation of said rotor; and
a controller housing portion extending from said motor housing portion beyond said exterior surface of said mounting plate such that said controller housing portion is at least partially disposed outside of said housing interior of said cage housing; and
an onboard controller in communication with said stator for selectively controlling energization of said stator, wherein said onboard controller is disposed in said controller housing portion of said motor assembly such that said onboard controller is external to said cage housing.

2. The high volume low speed fan of claim 1, wherein said mounting plate defines a central void extending between said interior surface and said exterior surface, and said controller housing portion extends through said central void such that said controller housing portion is at least partially disposed outside of said housing interior of said cage housing.

3. The high volume low speed fan of claim 2, wherein said controller housing portion is coupled to said motor housing portion such that said controller housing portion is cantilevered from said motor housing portion through said central void of said mounting plate.

4. The high volume low speed fan of claim 1, wherein said rear cage section includes a rear frame ring and a rear radial frame member extending radially between said rear frame ring and said mounting plate to support said mounting plate.

5. The high volume low speed fan of claim 1, further comprising an orifice ring coupled to said rear cage section of said cage housing and extending away from said rear cage section of said cage housing, said orifice ring configured to reduce turbulence during rotation of said fan assembly about said central axis.

6. The high volume low speed fan of claim 5, wherein said orifice ring extends from an inward end coupled to said cage housing to a flared outward end, and wherein said orifice ring defines an inner surface and an opposing outer surface that extend substantially parallel to one another for a first length and curve away from said central axis for a second length to said flared outward end.

7. The high volume low speed fan of claim 6, wherein said inner surface and said opposing outer surface each have a substantially constant curvature along said second length.

8. The high volume low speed fan of claim 6, wherein said inner surface of said orifice ring has a first diameter along said first length, said first diameter less than a diameter of said cylindrical cage section.

9. A directional fan system comprising:
a directional fan assembly including
a cage housing including a front cage section, a rear cage section spaced from said front cage section along a central axis and including a mounting plate, and a cylindrical cage section disposed annularly about said central axis and extending between said front cage section and said rear cage section such that said front cage section, said rear cage section, and said cylindrical cage section cumulatively define a housing interior;
a central hub supported for rotation about said central axis; and
a plurality of airfoils coupled to and distributed circumferentially about said central hub for rotation about said central axis with said central hub;
a motor assembly coupled to said mounting plate of said rear cage section of said cage housing and including a motor shaft coupled to said central hub such that said central hub and said plurality of airfoils rotate about said central axis in response to rotation of said motor shaft; and
a mounting assembly configured to support said directional fan assembly relative to a mounting structure, said mounting assembly comprising:
an upper mounting bracket assembly configured to be coupled to the mounting structure;
an extension member having a top portion coupled to said upper mounting bracket assembly and a bottom portion; and
a lower mounting bracket assembly including a yoke having a first yoke arm coupled to said mounting plate, a second yoke arm coupled to said mounting plate and spaced from said first yoke arm, and a central yoke portion coupled to and extending between said first yoke arm and said second yoke arm, with said central yoke portion coupled to said bottom portion of said extension member, wherein said yoke is pivotably coupled to one of said mounting plate and said bottom portion of said extension member such that said yoke is pivotable about a pivot axis to adjust an orientation of said directional fan assembly.

10. The directional fan system of claim 9, wherein said motor assembly further includes:
a motor housing portion coupled to said mounting plate;
a stator disposed in said motor housing portion; and
a rotor disposed in said motor housing portion and configured for rotation about said central axis in response to energization of said stator, wherein said motor shaft extends between said rotor and said central hub such that said central hub and said plurality of airfoils rotate about said central axis in response to rotation of said rotor.

11. The directional fan system of claim 10, wherein motor assembly further includes:
a controller housing portion extending from said motor housing portion; and
an onboard controller in communication with said stator for selectively controlling energization of said stator, wherein said onboard controller is disposed in said controller housing portion.

12. The directional fan system of claim 9, wherein said yoke is pivotably coupled to said mounting plate; and
wherein said lower mounting bracket assembly further includes a first adjustment plate interposed between said first yoke arm and said mounting plate and a second adjustment plate interposed between said second yoke arm and said mounting plate, wherein each of said first adjustment plate and said second adjustment plate define a plurality of adjustment holes spaced radially from and distributed circumferentially about said pivot axis, and wherein said lower mounting bracket assembly further comprises a fastener disposable through a selected adjustment hole of said plurality of adjustment holes to retain said yoke at a one of a plurality of predefined orientations relative to said mounting plate.

13. The directional fan system of claim 12, further comprising a brace extending from said rear cage section, said brace extending along an arc and defining a plurality of bracing holes along said arc at a plurality of locations along said arc corresponding to said plurality of adjustment holes; and
wherein said extension member defines a locking hole arranged to be aligned with one of said plurality of bracing holes at each predefined orientation of said yoke relative to said mounting plate for receiving a fastener through said locking hole and said one of said plurality of bracing holes to further retain said yoke at said one of said plurality of predefined orientations relative to said mounting plate.

14. The directional fan system of claim 9, wherein said yoke is pivotably coupled to said bottom portion of said extension member; and
wherein said central yoke portion of said yoke defines a plurality of adjustment holes spaced radially from and distributed circumferentially about said pivot axis, and wherein said lower mounting bracket assembly further comprises a fastener disposable through a selected adjustment hole of said plurality of adjustment holes to retain said yoke at one of a plurality of predefined orientations relative to said extension member.

15. The directional fan system of claim 9, wherein said extension member is rotatable about a longitudinal axis extending along a length of said extension member for adjusting the orientation of said directional fan assembly in a second degree of freedom transverse to said pivot axis.

16. The directional fan system of claim 9, wherein said upper mounting bracket assembly comprises:
a top plate configured to be coupled to a ceiling mounting structure; and
a pair of adjustment brackets extending from said top plate and defining coaxial bores, wherein said top portion of said extension member is coupled to said pair of adjustment brackets via a fastener disposed through said coaxial bores.

17. The directional fan system of claim 16, wherein said defining coaxial bores define an adjustment axis and said extension member is pivotable about said adjustment axis, and wherein each adjustment bracket of said pair of adjustment brackets defines an adjustment slot radially spaced from said adjustment axis, and wherein said upper mounting bracket assembly further comprises at least one fastener disposable through said adjustment slot to retain said extension member at an orientation relative to said top plate.

18. The directional fan system of claim 9, wherein said upper mounting bracket assembly comprises:
a back plate configured to be coupled to a wall or column mounting structure; and
a pair of mounting brackets extending from said back plate and defining coaxial bores defining an adjustment axis, wherein said top portion of said extension member is coupled to said pair of adjustment brackets via a fastener disposed through said coaxial bores such that said extension member is pivotable about said adjustment axis.

19. The directional fan system of claim 18, wherein each mounting bracket of said pair of mounting brackets defines an adjustment slot radially spaced from said adjustment axis, and wherein said upper mounting bracket assembly further comprises at least one fastener receivable through said adjustment slot to retain said extension member at a selected angular orientation relative to said back plate.

20. A method of mounting a directional fan assembly to a ceiling mounting structure, said method comprising:
coupling a top plate of an upper mounting bracket assembly to the ceiling mounting structure, the upper mounting bracket assembly including a pair of adjustment brackets defining:
coaxial bores defining an adjustment axis; and
an adjustment slot radially spaced from the adjustment axis;
coupling a top portion of an extension member to the pair of adjustment brackets by disposing a fastener through the coaxial bores and the top portion of the extension member such that the extension member is pivotable about the adjustment axis;
coupling a bottom portion of the extension member to a directional fan assembly with a lower bracket assembly such that the directional fan assembly is supported by the extension member;
adjusting the lower bracket assembly to support the directional fan assembly at an orientation relative to the extension member;
permitting the extension member, the lower bracket assembly, and the directional fan assembly to pivot about the adjustment axis until the extension member, the lower bracket assembly, and the directional fan assembly reach a static equilibrium orientation relative to the upper mounting bracket assembly; and
disposing a fastener through the adjustment slot and the top portion of the extension member to retain the extension member, the lower bracket assembly, and the directional fan assembly at the static equilibrium orientation.
